(19) United States
(12) Patent Application Publication
(10) Pub. No.: US 2026/0251965 A1
(43) Pub. Date: Aug. 27, 2026

(54) PROJECTION SCREEN WITH NANO-SCALE MICROCRYSTALLINE STRUCTURE AND MANUFACTURING METHOD THEREOF

(71) Applicant: SHENZHEN MICROCRYSTALLINE VISION TECHNOLOGY CO., LTD, SHENZHEN (CN)

(72) Inventors: XIANJUN DENG, SHENZHEN (CN); YI GAO, SHENZHEN (CN)

(21) Appl. No.: 18/725,753

(22) PCT Filed: Apr. 2, 2024
(86) PCT No.: PCT/CN2024/085452

§ 371 Date: Jun. 28, 2024

(30) Foreign Application Priority Data
Apr. 27, 2023 (CN) 202310469406.3

(51) Int. Cl. G03B 21/60

(52) U.S. Cl. CPC G03B 21/60

(57) ABSTRACT

Provided are a projection screen with a nano-scale microcrystalline structure and a manufacturing method thereof. In the present application, a reflective layer is attached to a structural layer composed of irregular arrays of continuous curved surfaces with different curvatures and different heights, and a nano-scale microcrystal layer composed of transparent crystals with inconsistent shapes and sizes is attached to the reflective layer. The structural layer provides the basic angular distribution and uniformity of reflected light in a space, and the nano-scale microcrystal layer refracts light to make the light efficiently distributed at a set spatial angle, which expands a viewing angle of a screen, improves the uniformity of a screen, optimizes the spatial distribution of a screen, and reduces the spatial distribution of reflected light in a non-main viewing zone to ensure a prominent viewing quality.

### CROSS REFERENCE TO RELATED APPLICATION

The present application is a national stage application of International Patent Application No. PCT/CN2024/085452, filed on Apr. 2, 2024, which claims priority to the Chinese Patent Application CN202310469406.3 filed to the China National Intellectual Property Administration (CNIPA) on Apr. 27, 2023 and entitled “PROJECTION SCREEN WITH NANO-SCALE MICROCRYSTALLINE STRUCTURE AND MANUFACTURING METHOD THEREOF”, which is incorporated herein by reference in its entirety.

### TECHNICAL FIELD

The present application relates to the technical field of projection imaging, and specifically, the present application mainly relates to a projection screen with a nano-scale microcrystalline structure and a manufacturing method thereof.

### BACKGROUND

Currently, projection screens are commonly used in cinemas, education industries, and corporate meetings. However, even the projection screens used in cinemas that represent the highest level in this industry are usually fabricated merely with a polyvinyl chloride (PVC) substrate, a flaky aluminum powder, and an outer protective layer, and often have a contrast of merely slightly more than 100. The projection screens used in cinemas often exhibit a variety of shortcomings such as obvious spot effects, insufficient resolution, easy damage to a screen, and easy attenuation of optical performance.

In the cinema system, the Lambertian diffuser of the traditional metal screen faces major problems such as small viewing angle. Because an intensity of the Lambertian diffuser undergoes cosine transform, actual brightnesses that can be observed by audiences at two sides are very small, which brings a very bad viewing experience. Because the radiance of scattered light of the Lambertian diffuser is independent of a direction, no auditorium seat is arranged at extreme angles (+-70-90°), but the light is still reflected indiscriminately to these regions, such that actual observation intensities of the zones at an absolute front (−5-5°) and a golden angle decrease. In order to solve these problems, the reflection angle of a reflective layer is increased by adding an irregular reflection optical structure layer in some metal screens, but the gain and polarization contrast of projection are reduced accordingly. Therefore, it is necessary to design a screen with a high brightness gain, a high polarization contrast, and a large reflection angle to improve a viewing quality.

### SUMMARY

An objective of the present application is to provide a projection screen with a nano-scale microcrystalline structure and a manufacturing method thereof in view of the above-mentioned shortcomings. The present application is intended to solve the technical problems such as insufficient reflection angle, insufficient brightness gain, and insufficient contrast in the prior art.

To solve the above technical problems, the present application adopts the following technical solutions:

The present application provides a manufacturing method of a projection screen with a nano-scale microcrystalline structure, including:

embossing a transparent adhesive or a transparent plastic body on a carrier substrate layer 1 by a pressing roll or a mold, such that the transparent adhesive or the transparent plastic body is attached as an undulating concave-convex surface to the carrier substrate layer 1 to form a structural layer 2;
adsorbing a reflective metal on a surface of the structural layer 2 through printing, spray-coating, deposition, vacuum evaporation, or electroplating to form a reflective layer 3 on the structural layer 2; and
attaching a nano-scale microcrystal layer 4 to a surface of the reflective layer 3 through coating or spray-coating, where the nano-scale microcrystal layer 4 includes two or more transparent three-dimensional crystals.

Further, the structural layer 2 presents as the undulating concave-convex surface, and is composed of irregular arrays of continuous curved surfaces with different curvatures and different heights.

Further, a curved surface height of the structural layer 2 is in a range of 10 μm to 100 μm.

Further, the transparent three-dimensional crystals in the nano-scale microcrystal layer 4 each are a tiny crystal material at a nano/micro-scale or a nanoparticle with a crystal structure, and have a size of 100 nm to 300 nm.

Further, a material of the nano-scale microcrystal layer 4 is one or a mixture of two to seven selected from the group consisting of zinc oxide, nano-kaolin, titanium dioxide, montmorillonite, silver, graphene, and alumina.

Further, the transparent three-dimensional crystals are micro-round spherical nanocrystals with inconsistent shapes and sizes and irregular distribution positions, which can avoid the generation of Moire patterns.

Further, the transparent three-dimensional crystals are cubic nanocrystals, cuboid nanocrystals, cylindrical nanocrystals, triangular nanocrystals, semi-cylindrical nanocrystals, or polyhedral nanocrystals, and have inconsistent shapes and sizes and irregular distribution positions.

Further, a material of the reflective layer 3 is selected from the group consisting of silver, aluminum, and nickel, and the reflective layer has a thickness of 80 nm to 500 nm.

Further, the method further includes:
attaching a dark-colored material to the surface of the structural layer 2 through deposition or electroplating to form a light-absorbing layer 5 on the structural layer 2, and then adsorbing the reflective metal on a surface of the light-absorbing layer 5 through the printing, the spray-coating, the deposition, the vacuum evaporation, or the electroplating to form the reflective layer 3 on the light-absorbing layer 5.

Further, a material of the light-absorbing layer 5 is selected from the group consisting of chromium and iron, and the light-absorbing layer has a thickness of 100 nm to 300 nm.

Further, the method further includes:
attaching a crystal layer 6 including at least one transparent nanofilm layer to the surface of the reflective layer 3 through deposition, vacuum evaporation, or electroplating, and then attaching the nano-scale microcrystal layer 4 to a surface of the crystal layer 6 through coating or spray-coating.

Further, each transparent nanofilm layer in the crystal layer 6 has a thickness of 50 nm to 200 nm, and there are no more than two transparent nanofilm layers in the crystal layer 6.

The present application also provides a projection screen with a nano-scale microcrystalline structure manufactured by the manufacturing method described above, where the projection screen with the nano-scale microcrystalline structure includes the carrier substrate layer 1, the structural layer 2, the reflective layer 3, and the nano-scale microcrystal layer 4 that are stacked sequentially from bottom to top.

Further, the projection screen with the nano-scale microcrystalline structure has a brightness coefficient of 4.032.

Further, the projection screen with the nano-scale microcrystalline structure has an effective scattering angle of 44°.

Further, the projection screen with the nano-scale microcrystalline structure has a polarization contrast of 3397.3:1.

Compared with the prior art, the present application has the following beneficial effects: Based on the traditional metal reflection screen, a reflective layer is attached to a structural layer composed of irregular arrays of continuous curved surfaces with different curvatures and different heights, and a nano-scale microcrystal layer composed of transparent crystals with inconsistent shapes and sizes is attached to the reflective layer. The structural layer provides the basic angular distribution and uniformity of reflected light in a space, and the nano-scale microcrystal layer refracts light to make the light efficiently distributed at a set spatial angle, which expands a viewing angle of a screen, improves the uniformity of a screen, optimizes the spatial distribution of a screen, and reduces the spatial distribution of reflected light in a non-main viewing zone to ensure a prominent viewing quality.

In the present application, a light-absorbing layer is also designed, which can effectively absorb a small amount of transmitted light through the reflective layer to avoid interference to an image and improve a polarization contrast of a system.

In the present application, a crystal layer including a transparent nanofilm layer is also provided, which can increase the adhesion to the reflective layer, protect the reflective layer, increase an effect of multiple reflections to strengthen the reflected light, and compensate the problem that some metals in a metallic reflective layer exhibit an insufficient reflectivity for specific visible light bands.

### BRIEF DESCRIPTION OF THE DRAWINGS

FIG. 1 is a flow chart of the manufacturing method of a projection screen with a nano-scale microcrystalline structure in an embodiment of the present application;

FIG. 2 is a schematic structural diagram of a projection screen with a nano-scale microcrystalline structure in an embodiment of the present application;

FIG. 3 is a schematic diagram of micro-round spheres in a nano-scale microcrystal layer in an embodiment of the present application;

FIG. 4 is a schematic diagram of transmitted light through a micro-round sphere in a nano-scale microcrystal layer in an embodiment of the present application; and

FIG. 5 is a schematic diagram of refraction and reflection of a crystal layer in an embodiment of the present application.

### REFERENCE NUMERALS

1: a carrier substrate layer, 2: a structural layer, 3: a reflective layer, 4: a nano-scale microcrystal layer, 5: a light-absorbing layer, and 6: a crystal layer.

### DETAILED DESCRIPTION OF THE EMBODIMENTS

The present application is further described below with reference to the accompanying drawings.

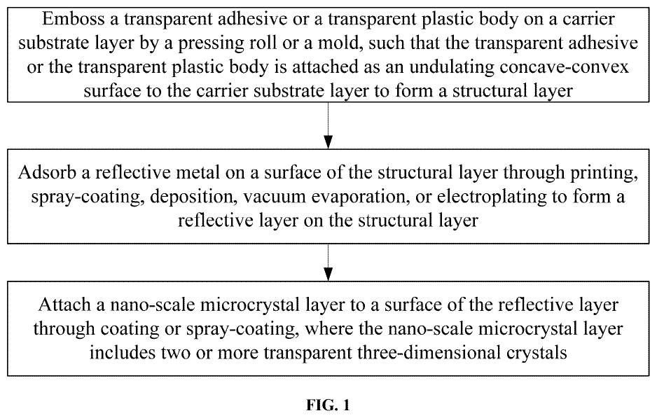

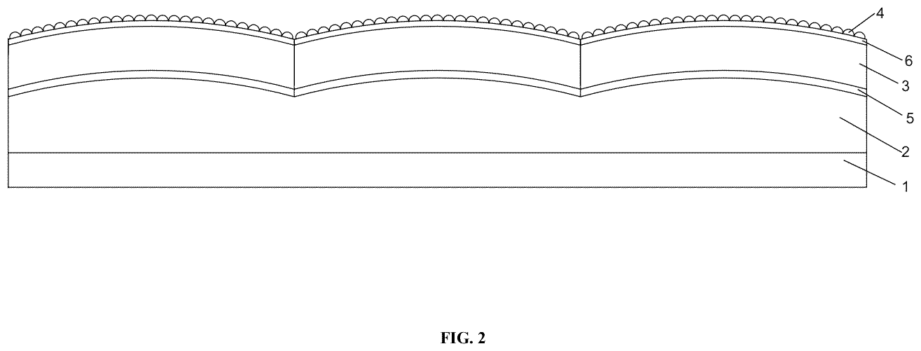

As shown in FIG. 1 and FIG. 2, a manufacturing method of a projection screen with a nano-scale microcrystalline structure is provided in an embodiment of the present application. Importantly, the manufacturing method includes:

a transparent adhesive or a transparent plastic body is embossed on a carrier substrate layer 1 by a pressing roll or a mold, such that the transparent adhesive or the transparent plastic body is attached as an undulating concave-convex surface to the carrier substrate layer 1 to form a structural layer 2;

a reflective metal is adsorbed on a surface of the structural layer 2 through printing, spray-coating, deposition, vacuum evaporation, or electroplating to form a reflective layer 3 on the structural layer 2; and

a nano-scale microcrystal layer 4 is attached to a surface of the reflective layer 3 through coating or spray-coating, where the nano-scale microcrystal layer 4 includes two or more transparent three-dimensional crystals with inconsistent shapes and sizes.

Specifically, the microcrystalline screen includes the carrier substrate layer 1 made of polycarbonate (PC), polyvinyl chloride (PVC), or polyethylene terephthalate (PET), and the structural layer 2 on the carrier substrate layer 1. A material of the structural layer 2 can be the transparent adhesive or the transparent plastic body, which is preferably processed by the mold into a required shape.

According to the Fresnel equation, when incident light is incident at an angle θᵢ to a medium interface, for s-polarized light,

$${r}_{⊥} = \frac{{n}_{i} cos {θ}_{i} - {n}_{t} cos {θ}_{t}}{{n}_{i} cos {θ}_{i} + {n}_{t} cos {θ}_{t}} ;$$

for p-polarized light,

$${r}_{∥} = \frac{{n}_{i} cos {θ}_{t} - {n}_{t} cos {θ}_{i}}{{n}_{i} cos {θ}_{t} + {n}_{t} cos {θ}_{i}} ;$$

and
for both polarization states: nᵢ sin θᵢ=nₜ sin θₜ.

For reflection under normal incidence, that is, θᵢ=0, a total reflectivity is as follows:

$$R = {( \frac{{n}_{t} - {n}_{i}}{{n}_{t} + {n}_{i}} )}^{2} .$$

For metallic media with a complex refractive index in a form of n-ik, such as aluminum (Al), silver (Ag), and gold (Au), a reflectivity under normal incidence in air is as follows:

$$R = \frac{{( 1 - n )}^{2} + {k}^{2}}{{( 1 + n )}^{2} + {k}^{2}} .$$

When light is incident at a specified inclination angle θᵢ, the calculation of a reflectivity is relatively complicated. When a metal layer is thick enough, reflectivities of p-polarized light and s-polarized light are as follows:

$${R}_{p} = \frac{{n}_{0}^{2} ( {a}^{2} + {b}^{2} ) + ( {n}^{2} + {k}^{2} ) cos {θ}_{i} - 2 {n}_{0} cos {θ}_{i} ( na + kb )}{{n}_{0}^{2} ( {a}^{2} + {b}^{2} ) + ( {n}^{2} + {k}^{2} ) cos {θ}_{i} + 2 {n}_{0} cos {θ}_{i} ( na + kb )}$$

$${R}_{s} = \frac{{n}_{0} {cos}^{2} {θ}_{i} + ( {a}^{2} + {b}^{2} ) ( {n}^{2} + {k}^{2} ) - 2 {n}_{0} cos {θ}_{i} ( na - kb )}{{n}_{0} {cos}^{2} {θ}_{i} + ( {a}^{2} + {b}^{2} ) ( {n}^{2} + {k}^{2} ) + 2 {n}_{0} cos {θ}_{i} ( na - kb )}$$

$$where a = \sqrt{\frac{\sqrt{{p}^{2} + {q}^{2}} + p}{2}} , b = \sqrt{\frac{\sqrt{{p}^{2} + {q}^{2}} - p}{2}} ,$$

$$p = 1 + ( {k}^{2} - {n}^{2} ) {( \frac{{n}_{0} sin {θ}_{i}}{{n}^{2} + {k}^{2}} )}^{2} , q = - 2 {nk ( \frac{{n}_{0} sin {θ}_{i}}{{n}^{2} + {k}^{2}} )}^{2} .$$

The reflectivities of p-polarized light and s-polarized light change with the change of an incident angle. However, it cannot absolutely eliminate undesired polarized light from the polarized light used in cinema systems and reality. In general applications, with s-polarized light as an example, if an intensity ratio of s-polarized light to p-polarized light is 1,000:1 or more, it can be considered as prominent linearly polarized light. There are improved standards for laser or cinema systems. In the present application, when p: s=1,000:1, light is incident on copper at an incident angle of about 50°, Rp is about 0.56, and Rs is about 0.76, p: s is about 736.8 after reflection. This phenomenon is very obvious if the calculation is conducted with circularly polarized light. Only an impact of a light intensity is calculated here, but there is actually a non-zero relative phase difference for s-polarized light and p-polarized light. Therefore, when incident light is linearly polarized light, light produced after reflection on an absorbing medium is usually called elliptically polarized light.

Therefore, in order to reduce the influence of this problem, a cinema system needs to provide a large angle to meet the requirements of audiences located in different positions. The structural layer 2 of the present application is presented as a specified undulating concave-convex surface, and is characterized by a continuously-controlled shape, which can avoid a large angle curve and a large change to reduce the above-mentioned influence on s-polarized light and p-polarized light. The overall undulating structure should have specified changes, where continuous curved surfaces with different curvatures and different heights should not form regular arrays, which can prevent the generation of Moire patterns. A curved surface height of the structural layer 2 is in a range of 10 μm to 100 μm.

In addition to controlling the spatial angle distribution of reflected light, the structural layer 2 is conducive to the angular scattering and uniformity of reflected light.

In addition, the transparent three-dimensional crystals in the nano-scale microcrystal layer 4 each are a tiny crystal material at a nano/micro-scale or a nanoparticle with a crystal structure, and have a size of 100 nm to 300 nm. The atomic arrangement of the transparent three-dimensional crystals is different from both an ordered crystalline state and a disordered amorphous state (glass state). The transparent three-dimensional crystals play a role of scattering light to make the light efficiently distributed at a set spatial angle, which expands a viewing angle of a screen and improves the uniformity of a screen.

A material of the nano-scale microcrystal layer 4 is one or a mixture of two to seven selected from the group consisting of zinc oxide, kaolin, titanium dioxide, montmorillonite, silver, graphene, and alumina.

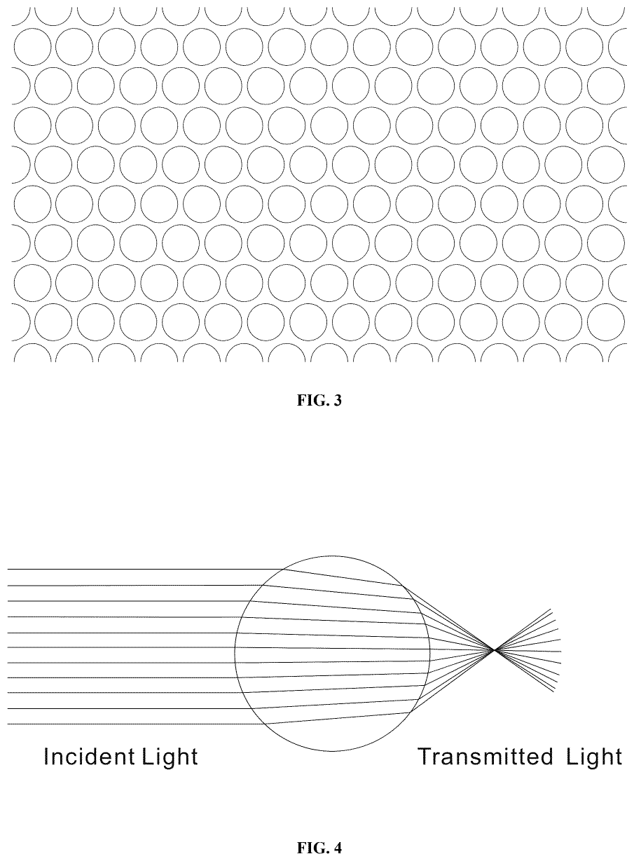

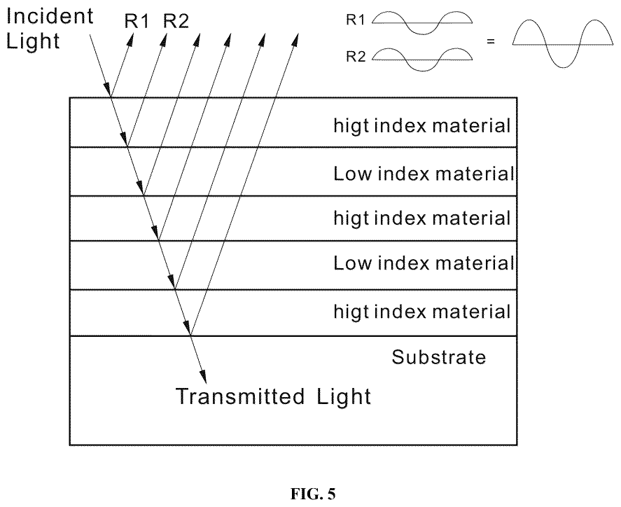

As shown in FIG. 3, in an embodiment, the transparent three-dimensional crystals are micro-round spherical nanocrystals, and incident light reflected by the reflective layer at a bottom can be regarded as parallel light. Thus, as shown in FIG. 4, transmitted light will gather at a point in front of the screen and diverge out, thereby playing a role of scattering light. A maximum angle is affected by a refractive index and shapes and sizes of the micro-round spherical nanocrystals. The shapes and sizes of the micro-round spherical nanocrystals are not completely standardized, and the sizes, shapes, and distribution positions of the micro-round spherical nanocrystals are different to avoid the generation of Moire patterns.

In other embodiments, the transparent three-dimensional crystals are cubic nanocrystals, cuboid nanocrystals, cylindrical nanocrystals, triangular nanocrystals, semi-cylindrical nanocrystals, or polyhedral nanocrystals, and have inconsistent shapes and sizes and irregular distribution positions, which can also allow a corresponding effect.

Beneficial effects of the present application: Based on the traditional metal reflection screen, the reflective layer 3 is attached to the structural layer 2 composed of irregular arrays of continuous curved surfaces with different curvatures and different heights, and the nano-scale microcrystal layer 4 composed of transparent three-dimensional crystals with inconsistent shapes and sizes is attached to the reflective layer. The structural layer 2 controls the spatial angle distribution of reflected light and the angular scattering and uniformity of reflected light. The nano-scale microcrystal layer 4 scatters light to make the light efficiently distributed at a set spatial angle, which expands a viewing angle of a screen, improves the uniformity of a screen, and reduces the reduction of a brightness gain of reflection of projection light while ensuring an observed brightness to ensure a prominent viewing quality.

More specifically, a material of the reflective layer 3 is selected from the group consisting of silver, aluminum, and nickel, and the reflective layer has a thickness of 80 nm to 500 nm. The reflective layer 3 is a metal reflective layer with a complex refractive index. The metal reflective layer should not be too thick to prevent the decrease in a reflectivity caused by increased scattering due to particle coarsening.

As a further design, the manufacturing method of a projection screen with a nano-scale microcrystalline structure further includes:

as shown in FIG. 2, a dark-colored material is attached to the surface of the structural layer 2 through deposition or electroplating to form a light-absorbing layer 5 on the structural layer 2, and then the reflective metal is adsorbed on a surface of the light-absorbing layer 5 through the printing, the spray-coating, the deposition, the vacuum evaporation, or the electroplating to form the reflective layer 3 on the light-absorbing layer 5.

When projected light is reflected by the reflective layer 3, the projected light cannot be 100% reflected, and about 0.001% or less of the projected light still penetrates through the reflective layer 3. The light-absorbing layer 5 is made of a dark-colored light-absorbing material. After irradiating the light-absorbing material, light is directly absorbed without transmission, mapping, large flares, and reflection. A material of the light-absorbing layer is preferably selected from the group consisting of chromium and iron, and the light-absorbing layer has a thickness of 100 nm to 300 nm. The dark-colored material of the light-absorbing layer 5 can absorb light of all colors, and the dark-colored material is attached to the structural layer 2 through deposition or electroplating.

The design of the light-absorbing layer 5 can effectively absorb a small amount of transmitted light through the reflective layer to avoid interference to an image and improve a polarization contrast of a system.

As a further design, the manufacturing method of a projection screen with a nano-scale microcrystalline structure further includes:

as shown in FIG. 2, a crystal layer 6 including at least one transparent nanofilm layer is attached to the surface of the reflective layer 3 through deposition, vacuum evaporation, or electroplating, and then the nano-scale microcrystal layer 4 is attached to a surface of the crystal layer 6 through coating or spray-coating.

Each transparent nanofilm layer in the crystal layer 6 has a thickness of 50 nm to 200 nm, and there are no more than two transparent nanofilm layers in the crystal layer 6.

The crystal layer 6 is designed as a multi-layer structure to allow the following major effects: 1. The crystal layer serves as a transition layer for increasing the adhesion to a metal layer. When the reflective layer 3 is a metal film layer, this transition layer is required because many working metals themselves have poor firmness and large absorption. The crystal layer is often made of a non-metallic oxide, and usually has a thickness of no more than 400 nm. 2. The crystal layer 6 can increase the protection for the reflective layer 3, that is, the crystal layer can improve the wear and corrosion resistance of the reflective layer and reduce the absorption of the reflective layer. Correspondingly, the crystal layer is a non-metallic oxide film layer with a thickness of usually about 50 nm to 200 nm and small absorption itself for light. The non-metallic oxide film layer is very stable, has wear and corrosion resistance, and shows very strong protection. 3. The crystal layer 6 can increase the reflection. Because the crystal layer includes a plurality of ¼ wavelength-thick transparent nanomaterial film layers with high and low refractive indexes, incident light will undergo a plurality of reflections after passing through the crystal layer 6. Due to the design of this structure, phases of reflected light among different layers are the same, as shown in FIG. 5, and the reflected light interference is enhanced, thereby playing a role of enhancing the reflected light. A plurality of layers with this structure are stacked to produce multi-layer reflection enhancement, which can further improve the reflectivity.

However, a number of such film layers should not be too large due to the following reasons: 1. The reflection enhancement is merely for a specific wavelength region, and does not for a broad spectrum range. If the number of such film layers is too large, the reflectivity cannot be significantly increased. 2. Such a structure has a specified negative effect on the maintenance of a polarization state of a system, and too many film layers will reduce a contrast. 3. Too many layers will increase a cost. However, this structure still has very important significance: 1. This structure itself can play a protective role for the reflective layer 3 to prevent the damage and wear of the metal film layer. 2. This structure can increase the reflection. A material of a specific metal reflective layer shows a low reflectivity for short-wavelength blue and violet light in a visible light range, and the reflection for this wavelength band needs to be enhanced to allow a high reflectivity for visible light as a whole, thereby ensuring an accuracy of a screen color. 3. This structure can reduce a defect loss. Due to a huge size of a screen, it is necessary to adopt some rapid coating processes to control a production cost. Generally, for the same coating process, the higher the deposition speed, the more the defects itself. Therefore, due to the consideration of a cost, there are many internal defects of a film such as particulate dust and microcracks, and a surface is relatively rough. In the present application, k_{H} and k_{L} are used to represent extinction coefficients of high-refractive-index and low-refractive-index materials, and n₀, n_{H}, and n_{L} are used to represent refractive indexes of high-refractive-index and low-refractive-index materials in the air. For a film layer in which high-refractive-index and low-refractive-index materials are stacked, when an outermost layer is a high-refractive-index film layer, an absorption loss is:

$$\frac{2 π {n}_{0} ( {k}_{H} + {k}_{L} )}{{n}_{H}^{2} - {n}_{L}^{2}} ;$$

and
when the outermost layer is a low-refractive-index film layer, an absorption loss is:

$$\frac{2 π ( {n}_{H}^{2} {k}_{H} + {n}_{L}^{2} {k}_{L} )}{{n}_{0} ( {n}_{H}^{2} - {n}_{L}^{2} )} .$$

Since refractive indexes of high-refractive-index and low-refractive-index film layers both are greater than 1, it can be known through simple calculations that an absorption loss of a low-refractive-index film layer is very low when the outermost layer is a high-refractive-index film layer. Therefore, when the outermost layer is a high-refractive-index material, a prominent reflectivity and a low loss can be allowed. This is also a function of the multi-layer structure of the crystal layer. Without this crystal layer, the metal reflective layer itself still requires a protective layer, and the protective layer itself generally has a very low refractive index (less than 1.5), which brings a high scattering loss. When the multi-layer structure is used for reflection enhancement and the outermost layer is ensured to be a high-refractive-index material, a scattering loss can be effectively reduced.

Therefore, there are no more than two nanofilm layers in the crystal layer 6.

The design of the crystal layer 6 including transparent nanofilm layers can increase the adhesion to the reflective layer, protect the reflective layer, increase an effect of multiple reflections to strengthen the reflected light, and compensate the problem that some metals in a metallic reflective layer exhibit an insufficient reflectivity for specific visible light bands.

In addition, as shown in FIG. 2, a projection screen with a nano-scale microcrystalline structure is provided, and the projection screen is manufactured by the manufacturing method according to any one of the above-mentioned technical solutions. The projection screen has functional advantages such as high brightness gain, high polarization contrast, and large scattering angle. The projection screen is subjected to brightness, effective scattering angle, polarization contrast tests with a metal screen designed with the existing metal reflective layer on the market to verify an effect of the projection screen, which is specifically as follows:

Brightness test: Samples of the projection screen with the nano-scale microcrystalline structure manufactured by the manufacturing method and the metal screen designed with a single-layer metal reflective layer on the market each are hung on a frame with a normal projection orientation perpendicular to a horizontal plane and a surface smooth. A recommended size of each sample is 297 mm×210 mm (width× height), and a minimum area of a sample test zone should be no less than 650 mm².

A projection device is positioned such that an optical axis of an objective lens is perpendicular to a surface of a screen sample to be tested and passes through a center of the surface. A projected beam of the projection device has an included angle of no more than 10° and should illuminate the entire screen sample, and a projection distance shall be slightly greater than a measurement distance of a brightness meter. The measurement distance of the brightness meter should be no less than 1 m and no more than 2 m. Brightness data are acquired by the brightness meter.

Measurement results show that the sample of the projection screen with the nano-scale microcrystalline structure manufactured by the manufacturing method has a brightness coefficient of 4.032, and the sample of the metal screen designed with the existing metal reflective layer on the market has a brightness coefficient of 2.145, indicating that the brightness of the projection screen with the nano-scale microcrystalline structure is significantly improved.

Effective scattering angle test: A brightness measurement device is adopted. A diffuse reflection plate with a known brightness coefficient Bb is placed at a center of a screen sample to be tested, and a projection device is parallelly turned on and focused. A brightness meter is placed on a horizontal plane passing through the center of the screen sample with a viewing angle of 5° between an optical axis of the brightness meter and a center normal line of a surface of the screen sample, and a surface reflection brightness L_{b} of the diffuse reflection plate is measured. The diffuse reflection plate is removed, a reflection brightness L_{y} at a center of the surface of the screen sample is measured by the brightness meter under the same conditions, and an effective scattering angle 2α should be measured immediately after the L_{y} is determined. A viewing angle of the brightness meter is gradually increased towards the normal line on an equally-ranging arc in a horizontal plane, and a reading change on the brightness meter is observed. When a brightness reading gradually drops to 50% of the L_{y} value, a horizontal included angle between a viewing sight line at a position of the brightness meter and the normal line of the center of the screen is α. When α values at left and right sides are symmetrical, 2×α is the effective scattering angle.

Measurement results show that the sample of the projection screen with the nano-scale microcrystalline structure manufactured by the manufacturing method has an effective scattering angle of 44°, and the sample of the metal screen designed with the existing metal reflective layer on the market has an effective scattering angle of 31°, indicating that the effective scattering angle of the projection screen with the nano-scale microcrystalline structure is significantly increased.

Polarization contrast test: A brightness measurement device is adopted, turned on, and focused. A first polarizer is placed in front of a lens of a slide projector or projection device, a second polarizer is placed in front of a brightness meter, and a brightness value of reflected light on a screen is measured. An angle of the second polarizer in front of the brightness meter is adjusted such that the first polarizer and the second polarizer are in a same polarization direction, and a maximum brightness value b is measured. Then the second polarizer is rotated by 90°, and a minimum brightness value c is measured. Then a polarization contrast is calculated according to the formula: R=b/c (where R represents a polarization contrast of a screen, which is expressed in a percentage (%); b represents a maximum brightness value measured when the first polarizer and the second polarizer are in a same polarization direction, which is in a unit of candela per square meter (cd/m²); and c represents a minimum brightness value measured when a polarization direction of the first polarizer is perpendicular to a polarization direction of the second polarizer, which is in a unit of candela per square meter (cd/m²)).

Measurement results show that the sample of the projection screen with the nano-scale microcrystalline structure manufactured by the manufacturing method has a polarization contrast of 3397.3:1, and the sample of the metal screen designed with the existing metal reflective layer on the market has a polarization contrast of 1490.8:1, indicating that the polarization contrast of the projection screen with the nano-scale microcrystalline structure is significantly improved.

It can be seen from the above test data that the projection screen with the nano-scale microcrystalline structure manufactured in the present application includes a structural layer 2 with an undulating concave-convex surface, a nano-scale microcrystal layer 4, a dark-colored material-based light-absorbing layer 5, and a crystal layer 6 including two microfilm layers, which can effectively guarantee an effective scattering angle, improve a brightness and a polarization contrast of a screen, and improve a projection reflection effect and a viewing quality.

Although the present application has been described in detail through the above embodiments, the embodiments are merely some rather than all of the embodiments of the present application. All other embodiments obtained by a person based on these embodiments without creative efforts shall fall within the protection scope of the present application.

1. A manufacturing method of a projection screen with a nano-scale microcrystalline structure, comprising:
embossing a transparent adhesive or a transparent plastic body on a carrier substrate layer (1) by a pressing roll or a mold, such that the transparent adhesive or the transparent plastic body is attached as an undulating concave-convex surface to the carrier substrate layer (1) to form a structural layer (2);
adsorbing a reflective metal on a surface of the structural layer (2) through printing, spray-coating, deposition, vacuum evaporation, or electroplating to form a reflective layer (3) on the structural layer (2); and
attaching a nano-scale microcrystal layer (4) to a surface of the reflective layer (3) through coating or spray-coating, wherein the nano-scale microcrystal layer (4) comprises two or more transparent three-dimensional crystals.

2. The manufacturing method according to claim 1, wherein the structural layer (2) presents as the undulating concave-convex surface, and is composed of irregular arrays of continuous curved surfaces with different curvatures and different heights.

3. The manufacturing method according to claim 2, wherein a curved surface height of the structural layer (2) is in a range of 10 μm to 100 μm.

4. The manufacturing method according to claim 1, wherein the transparent three-dimensional crystals in the nano-scale microcrystal layer (4) each are a tiny crystal material at a nano/micro-scale or a nanoparticle with a crystal structure, and have a size of 100 nm to 300 nm.

5. The manufacturing method according to claim 4, wherein a material of the nano-scale microcrystal layer (4) is one or a mixture of two to seven selected from the group consisting of zinc oxide, nano-kaolin, titanium dioxide, montmorillonite, silver, graphene, and alumina.

6. The manufacturing method according to claim 4, wherein the transparent three-dimensional crystals are micro-round spherical nanocrystals.

7. The manufacturing method according to claim 4, wherein the transparent three-dimensional crystals are cubic nanocrystals, cuboid nanocrystals, cylindrical nanocrystals, triangular nanocrystals, semi-cylindrical nanocrystals, or polyhedral nanocrystals.

8. The manufacturing method according to claim 1, wherein a material of the reflective layer (3) is selected from the group consisting of silver, aluminum, and nickel, and the reflective layer has a thickness of 80 nm to 500 nm.

9. The manufacturing method according to claim 1, further comprising:
attaching a dark-colored material to the surface of the structural layer (2) through deposition or electroplating to form a light-absorbing layer (5) on the structural layer (2), and then adsorbing the reflective metal on a surface of the light-absorbing layer (5) through the printing, the spray-coating, the deposition, the vacuum evaporation, or the electroplating to form the reflective layer (3) on the light-absorbing layer (5).

10. The manufacturing method according to claim 9, wherein a material of the light-absorbing layer (5) is selected from the group consisting of chromium and iron, and the light-absorbing layer has a thickness of 100 nm to 300 nm.

11. The manufacturing method according to claim 1, further comprising:
attaching a crystal layer (6) comprising at least one transparent nanofilm layer to the surface of the reflective layer (3) through deposition, vacuum evaporation, or electroplating, and then attaching the nano-scale microcrystal layer (4) to a surface of the crystal layer (6) through coating or spray-coating.

12. The manufacturing method according to claim 11, wherein each transparent nanofilm layer in the crystal layer (6) has a thickness of 50 nm to 200 nm, and there are no more than two transparent nanofilm layers in the crystal layer (6).

13. A projection screen with a nano-scale microcrystalline structure manufactured by the manufacturing method according to claim 1, wherein the projection screen with the nano-scale microcrystalline structure comprises the carrier substrate layer (1), the structural layer (2), the reflective layer (3), and the nano-scale microcrystal layer (4) that are stacked sequentially from bottom to top.

14. The projection screen with the nano-scale microcrystalline structure according to claim 13, wherein the projection screen with the nano-scale microcrystalline structure has a brightness coefficient of 4.032.

15. The projection screen with the nano-scale microcrystalline structure according to claim 13, wherein the projection screen with the nano-scale microcrystalline structure has an effective scattering angle of 44°.

16. The projection screen with the nano-scale microcrystalline structure according to claim 13, wherein the projection screen with the nano-scale microcrystalline structure has a polarization contrast of 3397.3:1.

17. The manufacturing method according to claim 9, further comprising:
attaching a crystal layer (6) comprising at least one transparent nanofilm layer to the surface of the reflective layer (3) through deposition, vacuum evaporation, or electroplating, and then attaching the nano-scale microcrystal layer (4) to a surface of the crystal layer (6) through coating or spray-coating.

18. The manufacturing method according to claim 10, further comprising:
attaching a crystal layer (6) comprising at least one transparent nanofilm layer to the surface of the reflective layer (3) through deposition, vacuum evaporation, or electroplating, and then attaching the nano-scale microcrystal layer (4) to a surface of the crystal layer (6) through coating or spray-coating.

19. The manufacturing method according to claim 17, wherein each transparent nanofilm layer in the crystal layer (6) has a thickness of 50 nm to 200 nm, and there are no more than two transparent nanofilm layers in the crystal layer (6).

20. The manufacturing method according to claim 18, wherein each transparent nanofilm layer in the crystal layer (6) has a thickness of 50 nm to 200 nm, and there are no more than two transparent nanofilm layers in the crystal layer (6).
